(19) United States
(12) Patent Application Publication
(10) Pub. No.: US 2026/0247353 A1
(43) Pub. Date: Aug. 20, 2026

(54) UE SENSING IN TDD SYSTEMS

(71) Applicant: QUALCOMM Incorporated, San Diego, CA (US)

(72) Inventors: Shijun WU, San Diego, CA (US); Kapil GULATI, Belle Mead, NJ (US); Stelios STEFANATOS, San Diego, CA (US); Preeti KUMARI, San Diego, CA (US)

(21) Appl. No.: 19/489,564

(22) PCT Filed: Jul. 5, 2024
(86) PCT No.: PCT/US2024/036858

§ 371 Date: Dec. 2, 2025

(30) Foreign Application Priority Data
Aug. 17, 2023 (GR) 20230100677

(51) Int. Cl. H04W 72/044; H04L 5/14; H04W 72/51

(52) U.S. Cl. CPC H04W 72/044; H04L 5/1469; H04W 72/51

(57) ABSTRACT

A method for wireless communication at a user equipment (UE) and related apparatus are provided. In the method, the UE receives a sensing configuration from a network entity. The sensing configuration may allocate one or more sensing resources for transmitting a sensing signal. The UE further transmits, using one sensing resource of the one or more sensing resources, the sensing signal for sensing an object in the vicinity of the UE, where the one sensing resource overlaps a downlink (DL) resource, and performs, based on the sensing signal to the object, a sensing operation on the object.

### CROSS-REFERENCE TO RELATED APPLICATION

This application claims the benefit of Greece Patent Application Serial No. 20230100677, entitled “UE SENSING IN TDD SYSTEMS” and filed on Aug. 17, 2023, which is expressly incorporated by reference herein in its entirety.

### TECHNICAL FIELD

The present disclosure relates generally to communication systems and, more particularly, to user equipment (UE) sensing in time division duplexed (TDD) systems for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a sensing configuration allocating one or more sensing resources for a transmission of a sensing signal; transmit, using one sensing resource of the one or more sensing resources, the sensing signal for sensing an object in the vicinity of the UE, where the one sensing resource overlaps with a downlink (DL) resource; and perform, based on the sensing signal, a sensing operation on the object.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, for a UE, a time division duplexing (TDD) configuration, where the TDD configuration allocates a DL resource; transmit, for the UE, a sensing configuration allocating one or more sensing resources to initiate the UE to transmit a sensing signal for sensing an object in the vicinity of the UE using the one or more sensing resources, where the one or more sensing resources overlap with the DL resource.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of UE determining the timing for sensing signal transmission in accordance with various aspects of the present disclosure.

FIG. 5 is a call flow diagram illustrating a method of wireless communication in accordance with various aspects of the present disclosure.

FIG. 6 is a flowchart illustrating methods of wireless communication at a UE in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a network entity in accordance with various aspects of the present disclosure.

FIG. 9 is a flowchart illustrating methods of wireless communication at a network entity in accordance with various aspects of the present disclosure.

FIG. 10 is a diagram illustrating an example of a hardware implementation for an example apparatus and/or network entity.

FIG. 11 is a diagram illustrating an example of a hardware implementation for an example network entity.

### DETAILED DESCRIPTION

The integration of sensing and communication systems for automotive can reduce hardware costs. In a joint sensing and communication system, the communication system may transmit a sensing signal to detect objects around a user equipment (UE), such as a vehicle, in a frequency band that was designated for cellular communication but is underutilized (e.g., the millimeter wave band). Transmitting sensing signals solely in uplink (UL) or flexible resources may lead to a UL-heavy time division duplexing (TDD) configuration and adversely affect the downlink (DL) throughput in the corresponding frequency band. Example aspects presented herein address these issues by introducing methods and apparatus that allow a UE to transmit sensing signals in DL slots/symbols.

Various aspects relate generally to wireless communication. Some aspects more specifically relate to UE sensing in TDD systems for wireless communication. In some examples, a UE may receive, from a network entity, a sensing configuration allocating one or more sensing resources for a transmission of a sensing signal; and transmitting, using one sensing resource of the one or more sensing resources, the sensing signal for sensing an object in the vicinity of the UE. The one sensing resource may overlap with a DL resource. The UE may further perform a sensing operation on the object based on the sensing signal. In some aspects, the UE may receive, prior to the reception of the sensing configuration, a TDD configuration that allocates the DL resource. The TDD configuration may be a common TDD configuration. In some aspects, the UE may receive the sensing configuration through common radio resource control (RRC) signaling or dedicated RRC signaling. In some aspects, the UE may transmit the sensing signal using a transmission timing configuration, and the transmission timing configuration may be based on a DL timing associated with the DL resource.

Particular aspects of the subject matter described in this disclosure can be implemented to realize one or more of the following potential advantages. In some aspects, by enabling the UE to transmit the sensing signal in DL slots/symbols, the described techniques address the challenge of balancing the DL-heavy TDD configuration in, for example, mmWave spectrum with the limited resources for sensing signal transmission, and hence improve the efficiency of wireless communication. In some aspects, by allowing the UE to utilize the DL resources to transmit sensing signals, the described techniques reduce the sensing signal overhead and improve the flexibility in how sensing signal resources are allocated or configured, thereby optimizing resource utilization.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

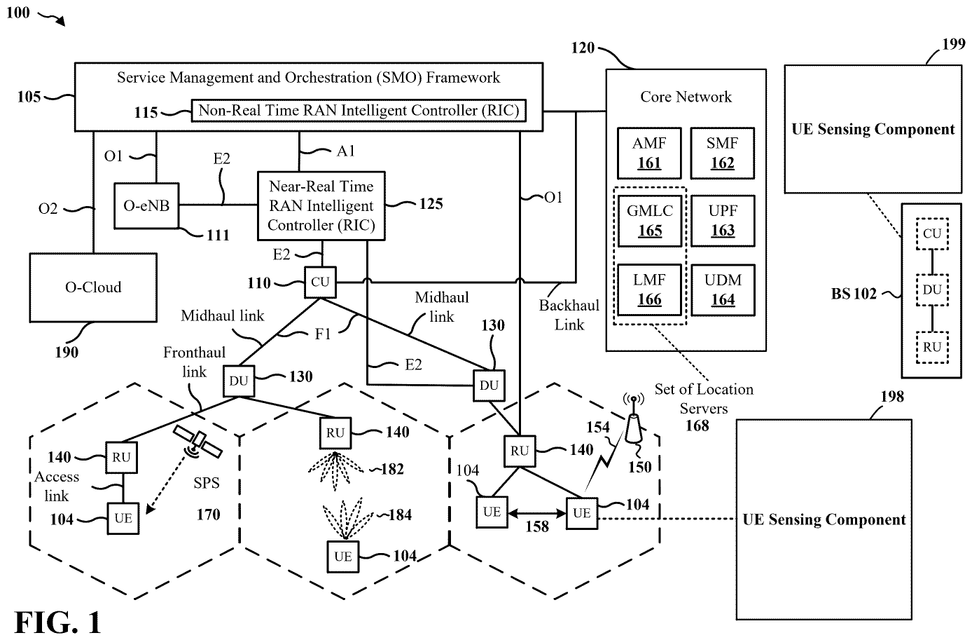

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the UE sensing component 198. The UE sensing component 198 may be configured to receive, from a network entity, a sensing configuration allocating one or more sensing resources for a transmission of a sensing signal; transmit, using one sensing resource of the one or more sensing resources, the sensing signal for sensing an object in the vicinity of the UE, where the one sensing resource overlaps with a DL resource; and perform, based on the sensing signal, a sensing operation on the object. In certain aspects, the base station 102 may include the UE sensing component 199. The UE sensing component 199 may be configured to transmit, for a UE, a TDD configuration, where the TDD configuration allocates a DL resource; transmit, for the UE, a sensing configuration allocating one or more sensing resources to initiate the UE to transmit a sensing signal for sensing an object in the vicinity of the UE using the one or more sensing resources. The one or more sensing resources may overlap with the DL resource. Although the following description may be focused on 5G NR, the concepts described herein may be applicable to other similar areas, such as LTE, LTE-A, CDMA, GSM, and other wireless technologies.

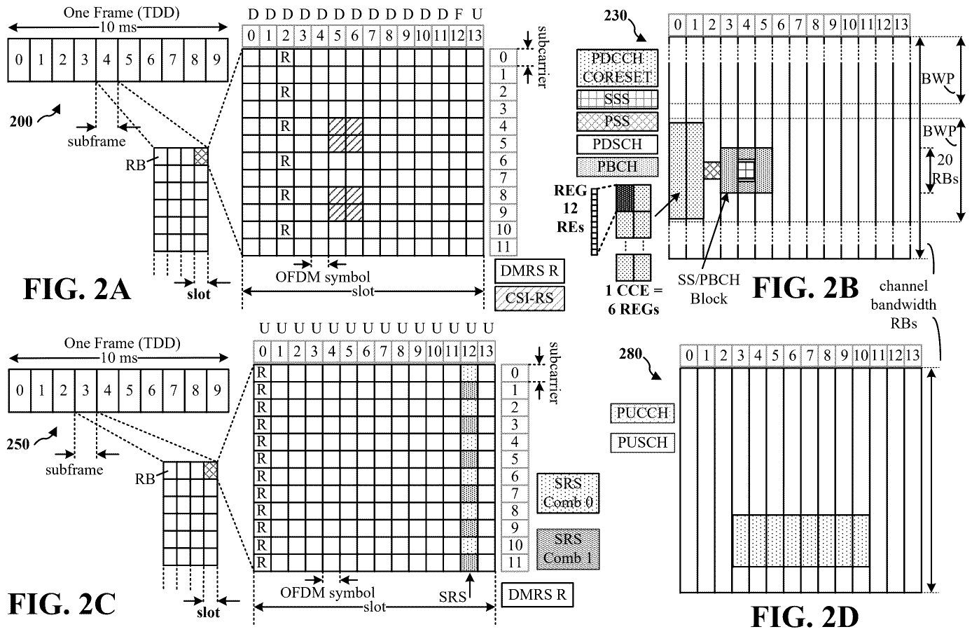

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

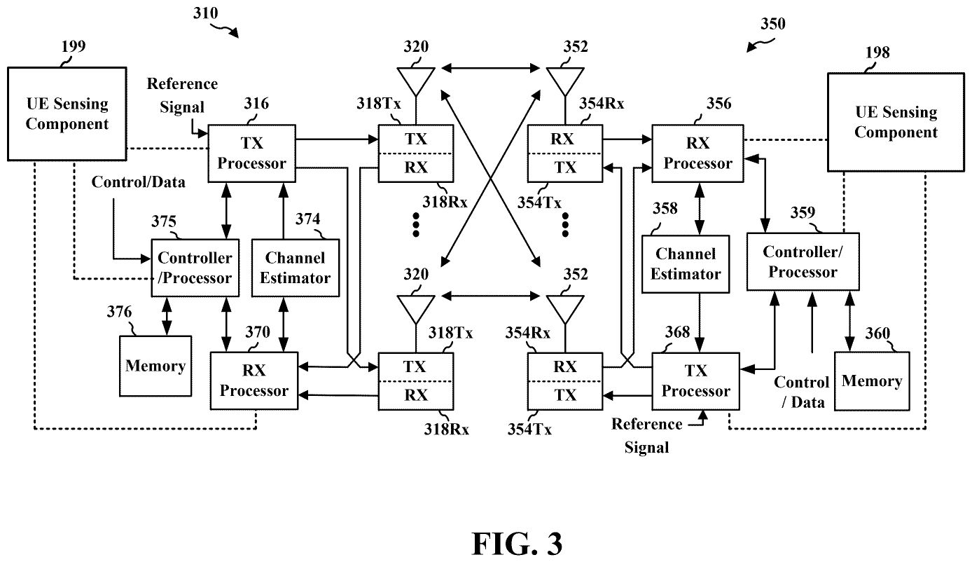

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE sensing component 198 of FIG. 1.

At least one of the TX processor 316, the RX processor 370, and the controller/processor 375 may be configured to perform aspects in connection with the UE sensing component 199 of FIG. 1.

Examples aspects presented herein provide methods and apparatus related to utilizing DL slots/symbols, as opposed to UL slots/symbols, in a TDD configuration for sensing purposes. The approach of using DL slots for the first stage in two-stage sensing and then UL slots for the second stage in two-stage sensing may help limit the interference limit.

Integrated sensing and communication (ISAC) for automotive applications offers joint design of sensing and communication systems and has the potential to reduce the hardware cost. In a joint sensing and communication system, a vehicle's communication system, which may be considered a user equipment (UE), may transmit signals for sensing purposes. For example, it may detect objects in the vehicle's vicinity by detecting the echo in a monostatic sensing operation that is full-duplex (FD) capable. To achieve a better synergy, the communication system may transmit sensing signals using the millimeter wave (mmWave or mmW) band, which was initially designated for cellular communication but is currently underutilized (e.g., for in-band operations).

For UE monostatic sensing, the sensing signal may be transmitted by the UE in the resources of the cellular system. The sensing signal may either use the same waveform as that of communication signals, such as cyclic prefix-orthogonal frequency division multiplexing (CP-OFDM), or use a different waveform, such as frequency modulated continuous wave (FMCW). Furthermore, a sensing reference signal (SRS) may be introduced as a sensing signal to meet various sensing conditions. The resources used for the SRS transmission may be configured or allocated by a network entity, e.g., gNB. In some examples, the sensing operations may use the resources that were dedicatedly allocated or configured for the sensing, such as time-division multiplexing (TDM). In some examples, the sensing operations may reuse existing communication resources.

Sensing resource overhead may depend on the sensing service condition. For UE sensing for automotive applications, the sensing signal bandwidth and duration may be sufficiently large to accommodate the desired range and velocity resolution. Furthermore, achieving the desired angular resolution might necessitate beam-sweeping for sensing signal transmission. Applications that come with elevated needs in range, velocity, and angle resolution may place a significant strain on the cellular system due to the heightened resource overhead. Two-stage sensing may reduce the sensing signal overhead. Two-stage sensing may involve a scanning stage that utilizes a smaller bandwidth and duration, possibly combined with a wide beam to identify the presence of potential objects. Once the objects are identified, the process transitions to the tracking stage, in which a larger bandwidth and/or duration, along with a narrower beam, may be used to detect the target of interest (potentially with fewer beams). Compared with single-stage sensing, two-stage sensing, or its multi-stage counterpart, may reduce the resource overhead.

Additionally, a comb-type sensing signal may also reduce the overhead. For example, in a time-domain comb transmission, the sensing signal may be mapped to a fraction of the slots or symbols. For example, a sensing signal may be mapped to every N-th symbol for a duration of a total of M sensing symbols. Then the sensing signal transmission would span across MN symbols in time. In the above example, the choice of M and N values may depend on the sensing condition and may impose certain limitations on the configuration and allocation of sensing signal resources.

In-band sensing may operate within a communication system that usually adopts the TDD mode. For example, the mmWave bands that are suitable for sensing, such as the 28 GHz band, have been designated for TDD operations. The mmWave bands usually have DL-heavy TDD configurations for enhancing the DL communication throughput.

For UE monostatic sensing (e.g., the UE both transmits and receives the sensing signal), transmitting the sensing signal in the UL or flexible resource in common practice (e.g., similar to the design for the sidelink communication). However, this choice may imply a UL-heavy TDD configuration to accommodate the transmission of the sensing signals. For example, a 4-symbol spacing (N=4) of the sensing signal transmission with a duration of 5 milliseconds (ms) may be necessary to achieve a velocity resolution of 1 m/s and a maximum velocity estimate of +/−75 m/s (assuming a 120 kHz SCS). This means that, during this 5 ms duration, the majority, if not all, of the resources would be configured as uplink resources. This UL-heavy TDD configuration adversely affects the DL throughput in the mmWave spectrum.

Example aspects present herein address these issues by allowing the UE to transmit the sensing signal in DL slots/symbols.

In some aspects, the network may configure the UE to transmit the sensing signal in DL slots/symbols. These DL slots/symbols may include, for example, the “D” resources configured by common TDD configuration. This configuration may enable the UE to transmit at least a part of the sensing signal in the “D” resources. The configuration may also be based on the UE's capabilities, the UE's sensing condition, the sensing mode (e.g., whether the UE monostatic sensing is in use), or the TDD configuration (e.g., whether the TDD configuration is DL-heavy).

For the UE transmitting the sensing signal in the “D” resources, the timing for the transmission may be determined based on the DL reference timing.

In one configuration, the slots/symbols for sensing may be configured in the “D” slots/symbols. For UEs that support UE monostatic sensing, the UE may be configured with slots/symbols for sensing signal transmission in the “D” slots/symbols (e.g., overriding the “D” slots/symbols in the TDD configuration). Depending on the configuration type, these “D” slots/symbols may be those configured in a common TDD configuration or UE-specific TDD configuration.

In some examples, the sensing slots/symbols configuration may be via common RRC signaling (e.g., carried in a new system information block (SIB) for sensing) or UE-specific RRC signaling (e.g., dedicated RRC signaling). The sensing UEs might not expect DL reception (Rx) during the slots/symbols that are overridden by the common configuration.

When considering the transmission of a UE's sensing signal, in one configuration, the network (e.g., a base station) may allocate resources in the configured sensing slots/symbols for the UE's sensing. Alternatively, in another configuration, the UE may select resources from the configured sensing slots/symbols for its sensing signal transmission.

In some aspects, the base station (BS) may configure or allocate resources for the transmission and reception of sensing signals in the “D” slots/symbols. In this method, there may not be any explicit signaling that overrides the designation of the “D” slots/symbols in the TDD configuration. Instead, the base station may directly configure or allocate resources for the sensing signal transmission, even if these resources may overlap with “D” slots/symbols in the TDD configuration. In some examples, the term “overlap with the “D” slots/symbols” may indicate at least a partial intersection with the “D” slots/symbols. For example, a portion of the configured/allocated resources for the sensing signal transmission may overlap with the “D” slots/symbols, while some other portions of the configured/allocated resources may not overlap with the “D” slots/symbols.

The signaling mechanism for the resource allocation/configuration for the UE's sensing signal transmission may be through various signaling pathways, including RRC signaling (e.g., via a dedicated RRC signal), medium access control (MAC)-control element (MAC-CE), or the physical (PHY) layer. In some examples, the sensing UEs may transmit the sensing signal in “D” slots/symbols if the configured/allocated resource for sensing is in “D” slots/symbols or overlap with “D” slots/symbols.

When the slots/symbols for sensing are configured in the “D” slots/symbols, a slot format (e.g., a sensing slot or a full duplex slot designated for the UE) or resource pool (e.g., resource pool used for UE sensing) configuration may be performed in the “D” slots/symbols first. Following this, the resources used for a UE's sensing signal transmission are then either allocated or selected from the sensing slot format or the resource pool. When the base station may configure or allocate resources for the transmission and reception of sensing signals in the “D” slots/symbols, the resources used for a UE's sensing signal transmission may be directly configured or allocated to the UE, and the configured/allocated resources might overlap with the “D” slots/symbols.

In some aspects, the configuration/allocation of the sensing resources in “D” slots/symbols may be based on the capability of the UE, and the UE may report to the network its capability (e.g., the capability on whether it can transmit within the “D” slots/symbols). In some examples, the configuration/allocation of the sensing resources in “D” slots/symbols may be based on the UE's sensing operation mode. For example, if a UE is set to perform monostatic sensing (e.g., the UE's sensing operation involves both transmission and reception within the sensing resources), the UE may be configured or allocated sensing resources in the “D” slots/symbols. In some examples, the configuration/allocation of the sensing resources in “D” slots/symbols may be based on UE's sensing condition or the TDD configuration (e.g., whether the TDD configuration is DL-heavy), or both. For example, if the uplink resources (“U” resources) or flexible resources (“F” resources) are incapable of meeting a sensing condition, the UE may be configured or allocated sensing resources in “D” slots/symbols. The sensing condition may include a resource amount condition for sensing the object or a velocity estimation condition for sensing the object. For example, if the “U” resources or the “F” resources can't fulfill the resources the UE requested or meet the velocity estimation condition for sensing, the UE may be configured/allocated sensing resources in “D” slots/symbols.

In some aspects, for two-stage or multi-stage sensing processes, not all stages may necessarily be performed on “D” slots/symbols. For example, the second stage of the two-stage sensing processing, which generally necessitates a more extended duration for the sensing signal transmission, might be performed in the “D” slots/symbols.

The timing for UE sensing signal transmission may be chosen in various ways. In one configuration, the UE may transmit the sensing signal using the “D” slots/symbols, and this transmission may use the DL timing. For example, both the UE's sensing signal transmission and the base station's DL signal transmission may share the same timing. The timing configuration may be specified or configured, and the UE may then determine the transmission timing according to this configuration.

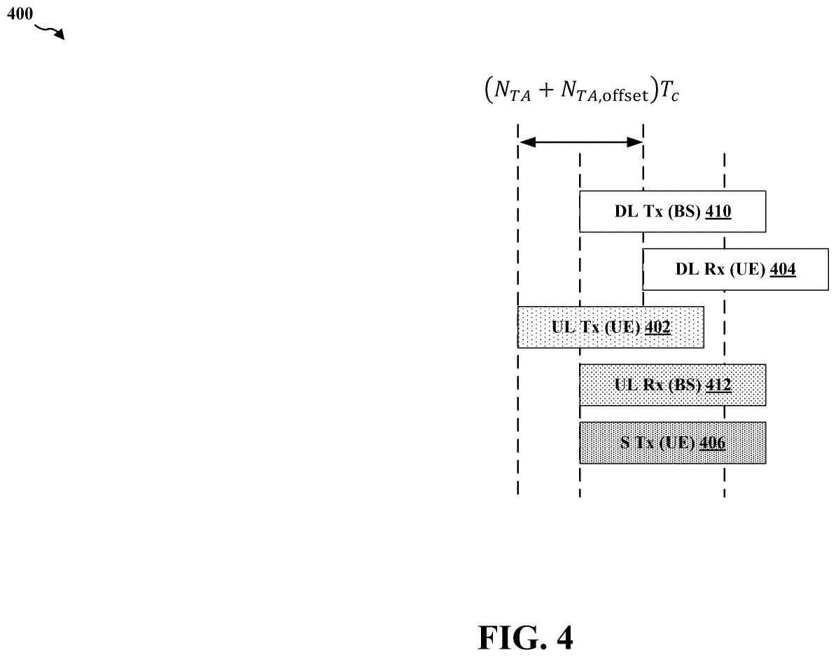

FIG. 4 is a diagram 400 illustrating an example of UE determining the timing for sensing signal transmission in accordance with various aspects of the present disclosure. In FIG. 4, when the UE determines the timing for its sensing signal transmission (or the DL timing) in TDD in, for example, the NR context, the UE's UL transmission (Tx) 402 may be set in advance by (N_{TA}+N_{TA,offset})T_{c} when compared to the time of DL reception (Rx) 404, where N_{TA} represents the timing advance (TA) obtained from the base station (e.g., during a random access channel (RACH) procedure), and N_{TA,offset} is a predefined value. When a UE transmits the sensing signal using the DL timing, the timing for this sensing signal's transmission (Tx) 406 can be advanced by

$$( {N}_{T A} / 2 + {N}_{TA , offset} ) {T}_{c} or \frac{{N}_{T A}}{2} {T}_{c} .$$

FIG. 4 also shows a DL transmission (Tx) 410 and an UL reception (Rx) 412.

In one configuration, the UE's sensing signal transmission timing may be indicated or configured by the network (e.g., by the base station). In this scenario, the base station may configure or indicate the timing for the UE's sensing signal transmission. In some examples, the timing configuration may be indicated to the UE when configuring resources for the UE's sensing signal transmission. The configurations or allocations may be dependent on the base station's specific implementation.

When the UE uses the DL timing for sensing signal transmission in “D” slots/symbols, the rules for determining the timing may be specified, and the UE is expected to adhere to the rules. On the other hand, when the UE's sensing signal transmission timing is indicated/configured by the network, the network may determine the UE's sensing transmission timing and indicate the timing to the UE.

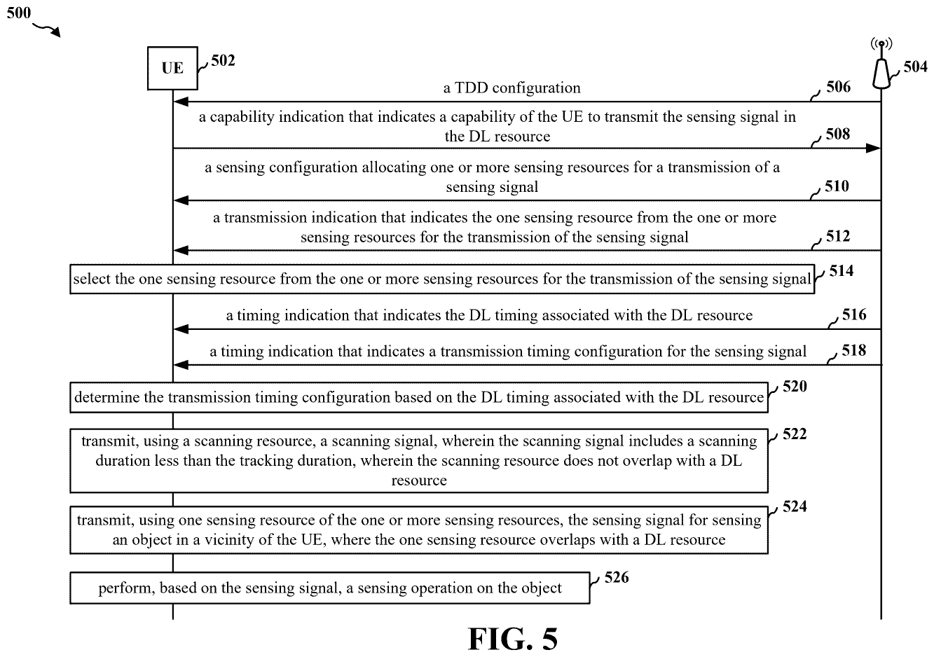

FIG. 5 is a call flow diagram 500 illustrating a method of wireless communication in accordance with various aspects of this present disclosure. Various aspects are described in connection with a UE 502 and a base station 504. The aspects may be performed by the UE 502 or the base station 504 in aggregation and/or by one or more components of a base station 504 (e.g., such as a CU 110, a DU 130, and/or an RU 140).

As shown in FIG. 5, at 506, the UE 502 may receive a TDD configuration. The TDD configuration may allocate a DL resource. In some examples, the TDD configuration may be a common TDD configuration. In some examples, the TDD configuration may be a UE-specific TDD configuration.

At 508, the UE 502 may transmit, to the base station 504, a capability indication. The capability indication may indicate, for example, whether the UE 502 has the capability to transmit the sensing signal in the DL resource.

At 510, the UE 502 may receive, from the base station 504, a sensing configuration allocating one or more sensing resources for the transmission of a sensing signal. In some examples, the sensing configuration may be based on the capability indication (at 508). For example, the base station 504 may transmit the sensing configuration to the UE 502 if the UE 502 indicates it has the capability to transmit the sensing signal in the DL resource. As used herein, the term “sensing configuration” may refer to the setup, such as resource allocation, used for sending and receiving sensing signals. “Sensing resources” may refer to the resources (e.g., frequency domain resources or time domain resources) designated for the transmission or reception of the sensing signal, and the “sensing signal” is the electromagnetic wave used to detect and monitor the movement of an object.

In some aspects, at 512, the UE 502 may receive a transmission indication that indicates the one sensing resource from the one or more sensing resources for the transmission of the sensing signal. In some examples, the one sensing resource may overlap with a DL resource.

In some aspects, at 514, the UE 502 may select the one sensing resource from the one or more sensing resources for the transmission of the sensing signal. In some examples, the one sensing resource may overlap with a DL resource.

In some aspects, at 516, the UE 502 may receive a timing indication that indicates the DL timing associated with the DL resource from the base station 504. In some examples, the UE 502 may transmit the sensing signal based on the timing indication.

In some aspects, at 518, the UE 502 may receive a timing indication that indicates the transmission timing configuration for the sensing signal from the base station 504. In some examples, the UE 502 may transmit the sensing signal based on the timing indication.

In some aspects, at 520, the UE 502 may determine the transmission timing configuration based on the DL timing associated with the DL resource. In some examples, the UE 502 may transmit the sensing signal based on the transmission timing configuration.

In some aspects, at 522, the UE 502 may transmit, using a scanning resource, a scanning signal. After sending the scanning signal, the UE 502 may further transmit the sensing signal, which may be a tracking signal. The tracking signal may include a tracking duration, and the scanning signal may include a scanning duration less than the tracking duration. In some examples, the scanning resource may not overlap with a DL resource. For example, in two-stage sensing, the scanning signal may be the first sensing signal the UE sends in the first stage of the sensing, and the tracking signal may be the second sensing signal the UE sends in the second stage of the sensing. In some examples, the second sensing signal (e.g., the tracking signal) may have a longer duration than the first sensing signal (e.g., the scanning signal).

At 524, the UE 502 may transmit, using one sensing resource of the one or more sensing resources, the sensing signal for sensing an object in the vicinity of the UE. The one sensing resource may overlap with a DL resource. In some examples, the one sensing resource may be the one sensing resource the UE selected at 514, or the one sensing resource indicated by the transmission indication at 512.

At 526, the UE 502 may perform, based on the sensing signal, a sensing operation on the object. The sensing operation on the object may involve determining the object's velocity, location, or orientation, for example. For example, the UE 502 may, based on a reflected signal received from the object, obtain the sensing information of the object, such as the velocity or range of the object.

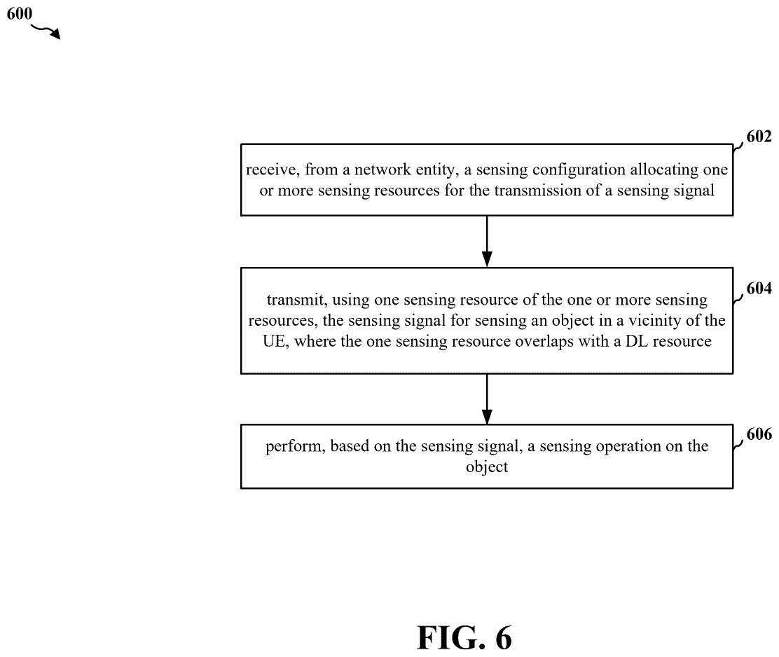

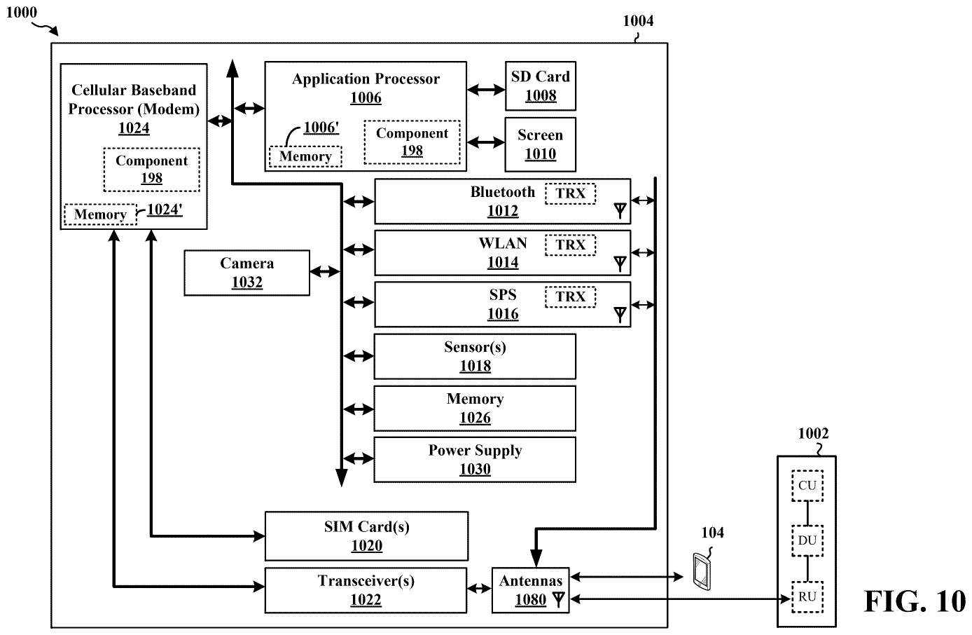

FIG. 6 is a flowchart 600 illustrating methods of wireless communication at a UE in accordance with various aspects of the present disclosure. The method may be performed by a UE. The UE may be the UE 104, 350, 502, or the apparatus 1004 in the hardware implementation of FIG. 10. The methods enable the UE to transmit the sensing signal in DL slots/symbols, which addresses the challenge of balancing the DL-heavy TDD configuration in, for example, mmWave spectrum with the limited resources for sensing signal transmission. These methods provide an efficient way to utilize the existing communication resources for enhanced sensing capabilities, thereby improving the efficiency of wireless communication.

As shown in FIG. 6, at 602, the UE may receive, from a network entity, a sensing configuration allocating one or more sensing resources for the transmission of a sensing signal. The network entity may be a base station, or a component of a base station, in the access network of FIG. 1 or a core network component (e.g., base station 102, 310, 504; or the network entity 1002 in the hardware implementation of FIG. 10). FIG. 5 illustrates various aspects of the steps in connection with flowchart 600. For example, referring to FIG. 5, the UE 502 may receive, at 510, from a network entity (base station 504), a sensing configuration allocating one or more sensing resources for the transmission of a sensing signal. In some aspects, 602 may be performed by the UE sensing component 198.

At 604, the UE may transmit, using one sensing resource of the one or more sensing resources, the sensing signal for sensing an object in the vicinity of the UE. The one sensing resource may overlap with a DL resource. For example, referring to FIG. 5, the UE 502 may transmit, at 524, using one sensing resource of the one or more sensing resources, the sensing signal for sensing an object in the vicinity of the UE 502. The one sensing resource may overlap with a DL resource. In some aspects, 604 may be performed by the UE sensing component 198.

At 606, the UE may perform a sensing operation on the object based on the sensing signal. For example, referring to FIG. 5, the UE 502 may perform, at 526, a sensing operation on the object based on the sensing signal. In some aspects, 606 may be performed by the UE sensing component 198.

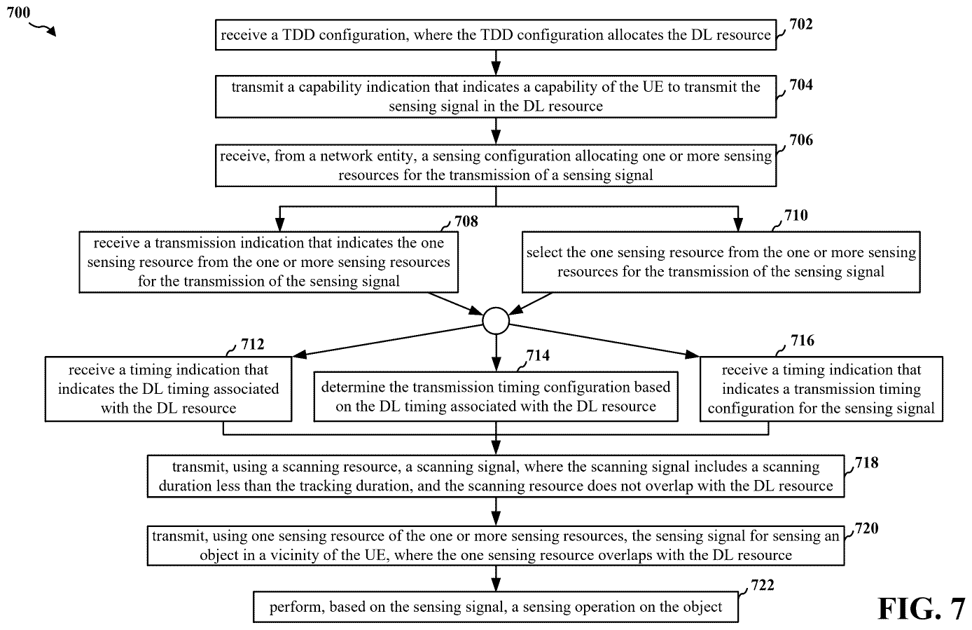

FIG. 7 is a flowchart 700 illustrating methods of wireless communication at a UE in accordance with various aspects of the present disclosure. The method may be performed by a UE. The UE may be the UE 104, 350, 502, or the apparatus 1004 in the hardware implementation of FIG. 10. The methods enable the UE to transmit the sensing signal in DL slots/symbols, which addresses the challenge of balancing the DL-heavy TDD configuration in, for example, mmWave spectrum with the limited resources for sensing signal transmission. These methods provide an efficient way to utilize the existing communication resources for enhanced sensing capabilities, thereby improving the efficiency of wireless communication.

As shown in FIG. 7, at 706, the UE may receive, from a network entity, a sensing configuration allocating one or more sensing resources for the transmission of a sensing signal. The network entity may be a base station, or a component of a base station, in the access network of FIG. 1 or a core network component (e.g., base station 102, 310, 504; or the network entity 1002 in the hardware implementation of FIG. 10). FIG. 4 and FIG. 5 illustrate various aspects of the steps in connection with flowchart 700. For example, referring to FIG. 5, the UE 502 may receive, at 510, from a network entity (base station 504), a sensing configuration allocating one or more sensing resources for the transmission of a sensing signal. In some aspects, 706 may be performed by the UE sensing component 198.

At 720, the UE may transmit, using one sensing resource of the one or more sensing resources, the sensing signal for sensing an object in the vicinity of the UE. The one sensing resource overlaps with the DL resource. For example, referring to FIG. 5, the UE 502 may transmit, at 524, using one sensing resource of the one or more sensing resources, the sensing signal for sensing an object in the vicinity of the UE 502. The one sensing resource may overlap with a DL resource. In some aspects, 720 may be performed by the UE sensing component 198.

At 722, the UE may perform a sensing operation on the object based on the sensing signal. For example, referring to FIG. 5, the UE 502 may perform, at 526, a sensing operation on the object based on the sensing signal. In some aspects, 722 may be performed by the UE sensing component 198.

In some aspects, the sensing signal may be in the mmW frequency band, and the sensing signal may use one of the CP-OFDM or the FMCW waveforms. For example, referring to FIG. 5, the sensing signal (the UE 502 transmits at 522) may be in the mmW frequency band, and the sensing signal (the UE 502 transmits at 522) may use one of the CP-OFDM waveform or the FMCW waveform.

In some aspects, at 702, the UE may receive, prior to the reception of the sensing configuration (at 706), a TDD configuration. The TDD configuration may allocate the DL resource. For example, referring to FIG. 5, the UE 502 may receive, at 506, a TDD configuration. The TDD configuration may allocate a DL resource. In some examples, the TDD configuration may be a common TDD configuration. In some examples, the TDD configuration may be a UE-specific TDD configuration. In some aspects, 702 may be performed by the UE sensing component 198.

In some aspects, the TDD configuration may be a common TDD configuration. For example, referring to FIG. 5, the TDD configuration (the UE 502 receives at 506) may be a common TDD configuration.

In some aspects, the one or more sensing resources may include multiple sensing resources, and the multiple sensing resources may overlap with the DL resource. In some examples, the term “overlap with the DL resource” may indicate at least a partial intersection with the DL resource. For example, a portion of the multiple sensing resources may overlap with the DL resource, while some other portions of the multiple may not overlap with the DL resource. For example, referring to FIG. 5, the one or more sensing resources (allocated at 510) may include multiple sensing resources, and the multiple sensing resources may overlap with the DL resource.

In some aspects, to receive the sensing configuration (at 706), the UE may receive, from the network entity, the sensing configuration via common RRC signaling. For example, referring to FIG. 5, the UE 502 may receive, at 510, the sensing configuration from the base station 504 via common RRC signaling.

In some aspects, to receive the sensing configuration (at 706), the UE may receive, from the network entity, the sensing configuration via dedicated RRC signaling. For example, referring to FIG. 5, the UE 502 may receive, at 510, the sensing configuration from the base station 504 via dedicated RRC signaling.

In some aspects, at 708, the UE may receive, from the network entity prior to the transmission of the sensing signal (at 720), a transmission indication that indicates the one sensing resource from the one or more sensing resources for the transmission of the sensing signal. For example, referring to FIG. 5, the UE 502 may receive, at 512, from the network entity (base station 504), a transmission indication that indicates the one sensing resource from the one or more sensing resources for the transmission of the sensing signal (at 524). In some aspects, 708 may be performed by the UE sensing component 198.

In some aspects, at 710, the UE may select the one sensing resource from the one or more sensing resources for the transmission of the sensing signal. For example, referring to FIG. 5, the UE 502 may select, at 514, the one sensing resource from the one or more sensing resources for the transmission of the sensing signal (at 524). In some aspects, 710 may be performed by the UE sensing component 198.

In some aspects, the one or more sensing resources (allocated at 706) may include one sensing resource for the transmission of the sensing signal, and, to receive the sensing configuration (at 706), the UE may receive the sensing configuration via one of the RRC signaling, a MAC-CE, or a PHY layer. For example, referring to FIG. 5, the one or more sensing resources (the UE 502 received at 510) may include one sensing resource for the transmission of the sensing signal (at 524). The UE 502 may receive the sensing configuration (at 510) via one of the RRC signaling, a MAC-CE, or a PHY layer.

In some aspects, at 704, the UE may transmit, to the network entity prior to the reception of the sensing configuration (at 706), a capability indication that indicates the capability of the UE to transmit the sensing signal in the DL resource, and the sensing configuration may be based on the capability indication. For example, referring to FIG. 5, the UE 502 may transmit, at 508, to the network entity (base station 504), a capability indication that indicates the capability of the UE to transmit the sensing signal in the DL resource. The base station 504 may transmit the sensing configuration (at 510) based on the capability indication. In some aspects, 704 may be performed by the UE sensing component 198.

In some aspects, to receive the sensing configuration (at 706), the UE may receive the sensing configuration in response to the UE operating in a monostatic sensing mode. For example, referring to FIG. 5, the UE 502 may receive, at 510, the sensing configuration when the UE 502 is operating in the monostatic sensing mode.

In some aspects, to receive the sensing configuration (at 706), the UE may receive the sensing configuration in response to uplink resources or flexible resources incapable of meeting a sensing condition. The sensing condition may include one or more of: a resource amount condition for sensing the object, or a velocity estimation condition for sensing the object. For example, referring to FIG. 5, the UE 502 may receive the sensing configuration (at 510) in response to uplink resources or flexible resources incapable of meeting a sensing condition. The sensing condition may include one or more of: a resource amount condition for sensing the object, or a velocity estimation condition for sensing the object.

In some aspects, the sensing signal (transmitted at 720) may be a tracking signal including a tracking duration, and the UE may, at 718, transmit, using a scanning resource prior to the transmission of the tracking signal (at 720), a scanning signal. The scanning signal may include a scanning duration less than the tracking duration, and the scanning resource does not overlap with a DL resource. For example, referring to FIG. 5, the UE 502 may transmit, at 522, a scanning signal using a scanning resource. After sending the scanning signal, the UE 502 may further transmit the sensing signal (at 524), which may be a tracking signal. The tracking signal may include a tracking duration, and the scanning signal may include a scanning duration less than the tracking duration. In some examples, the scanning resource may not overlap with a DL resource. For example, in two-stage sensing, the scanning signal may be the first sensing signal the UE sends in the first stage of the sensing, and the tracking signal may be the second sensing signal the UE sends in the second stage of the sensing. In some examples, the second sensing signal (e.g., the tracking signal) may have a longer duration than the first sensing signal (e.g., the scanning signal). In some aspects, 718 may be performed by the UE sensing component 198.

In some aspects, to transmit the sensing signal (at 720), the UE may transmit the sensing signal using a transmission timing configuration, and the transmission timing configuration is based on a DL timing associated with the DL resource. For example, referring to FIG. 5, the UE 502 may transmit, at 524, the sensing signal using a transmission timing configuration, and the transmission timing configuration is based on a DL timing associated with the DL resource.

In some aspects, at 712, the UE may receive, from the network entity prior to the transmission of the sensing signal (at 720), a timing indication that indicates the DL timing associated with the DL resource. For example, referring to FIG. 5, the UE 502 may receive, at 516, from the network entity (base station 504), a timing indication that indicates the DL timing associated with the DL resource. In some aspects, 712 may be performed by the UE sensing component 198.

In some aspects, at 714, the UE may determine the transmission timing configuration based on the DL timing associated with the DL resource. For example, referring to FIG. 5, the UE 502 may determine, at 520, the transmission timing configuration based on the DL timing associated with the DL resource. Referring to FIG. 4, the UE may determine the transmission timing configuration based on the DL timing associated with the DL resource (e.g., the timings for the UE's UL transmission 402 and DL reception 404). In some aspects, 714 may be performed by the UE sensing component 198.

In some aspects, at 716, the UE may receive, from the network entity prior to the transmission of the sensing signal (at 720), a timing indication that indicates a transmission timing configuration for the sensing signal. To transmit the sensing signal (at 720), the UE may transmit the sensing signal using the transmission timing configuration. For example, referring to FIG. 5, the UE 502 may receive, at 518, from the network entity (base station 504), a timing indication that indicates a transmission timing configuration for the sensing signal. To transmit the sensing signal (at 524), the UE 502 may transmit the sensing signal using the transmission timing configuration. In some aspects, 716 may be performed by the UE sensing component 198.

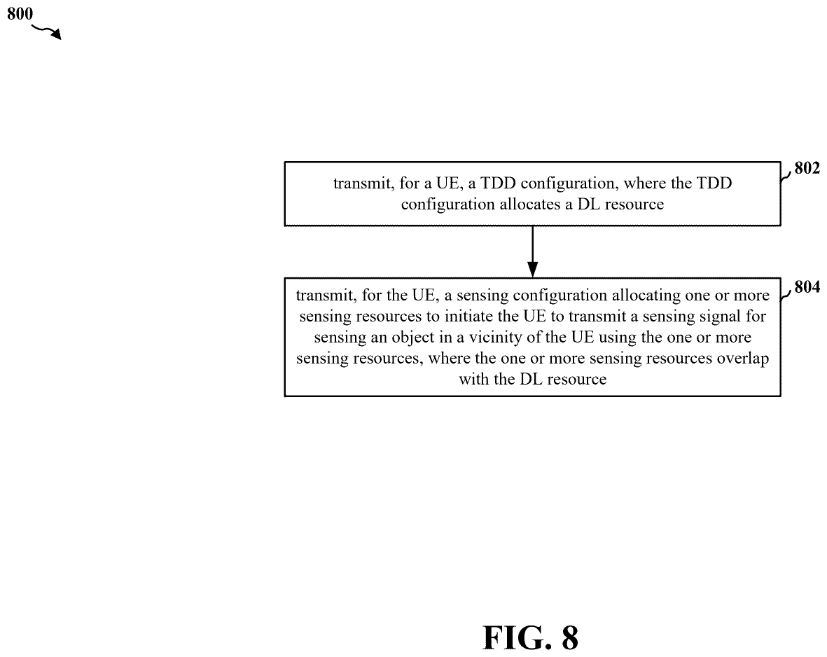

FIG. 8 is a flowchart 800 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 504; or the network entity 1002 in the hardware implementation of FIG. 10). The methods enable the UE to transmit the sensing signal in DL slots/symbols, which addresses the challenge of balancing the DL-heavy TDD configuration in, for example, mmWave spectrum with the limited resources for sensing signal transmission. These methods provide an efficient way to utilize the existing communication resources for enhanced sensing capabilities, thereby improving the efficiency of wireless communication.

As shown in FIG. 8, at 802, the network entity may transmit, for a UE, a TDD configuration. The TDD configuration may allocate a DL resource. The UE may be the UE 104, 350, 502, or the apparatus 1004 in the hardware implementation of FIG. 10. FIG. 5 illustrates various aspects of the steps in connection with flowchart 800. For example, referring to FIG. 5, the network entity (base station 504) may transmit, at 506, for a UE 502, a TDD configuration. The TDD configuration may allocate a DL resource. In some aspects, 802 may be performed by the UE sensing component 199.

At 804, the network entity may transmit, for the UE, a sensing configuration allocating one or more sensing resources to initiate the UE to transmit a sensing signal for sensing an object in the vicinity of the UE using the one or more sensing resources. The one or more sensing resources may overlap with the DL resource. For example, referring to FIG. 5, the network entity (base station 504) may transmit, at 510, for the UE 502, a sensing configuration allocating one or more sensing resources to initiate the UE to transmit a sensing signal (at 524) for sensing an object in the vicinity of the UE using the one or more sensing resources. The one or more sensing resources may overlap with the DL resource. In some aspects, 804 may be performed by the UE sensing component 199.

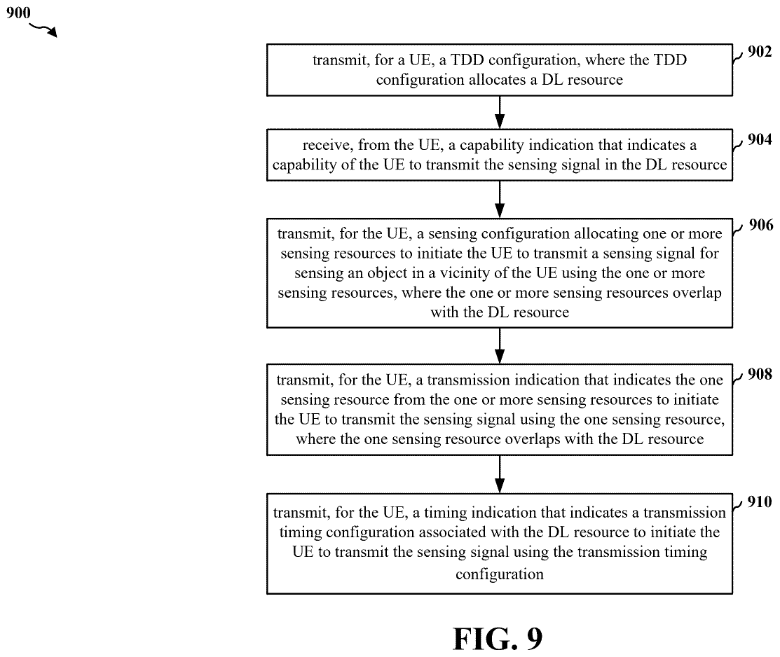

FIG. 9 is a flowchart 900 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 504; or the network entity 1002 in the hardware implementation of FIG. 10). The methods enable the UE to transmit the sensing signal in DL slots/symbols, which addresses the challenge of balancing the DL-heavy TDD configuration in, for example, mmWave spectrum with the limited resources for sensing signal transmission. These methods provide an efficient way to utilize the existing communication resources for enhanced sensing capabilities, thereby improving the efficiency of wireless communication.

As shown in FIG. 9, at 902, the network entity may transmit, for a UE, a TDD configuration. The TDD configuration may allocate a DL resource. The UE may be the UE 104, 350, 502, or the apparatus 1004 in the hardware implementation of FIG. 10. FIG. 5 illustrates various aspects of the steps in connection with flowchart 900. For example, referring to FIG. 5, the network entity (base station 504) may transmit, at 506, for a UE 502, a TDD configuration. The TDD configuration may allocate a DL resource. In some aspects, 902 may be performed by the UE sensing component 199.

At 906, the network entity may transmit, for the UE, a sensing configuration allocating one or more sensing resources to initiate the UE to transmit a sensing signal for sensing an object in the vicinity of the UE using the one or more sensing resources. The one or more sensing resources may overlap with the DL resource. For example, referring to FIG. 5, the network entity (base station 504) may transmit, at 510, for the UE 502, a sensing configuration allocating one or more sensing resources to initiate the UE to transmit a sensing signal (at 524) for sensing an object in the vicinity of the UE using the one or more sensing resources. The one or more sensing resources may overlap with the DL resource. In some aspects, 906 may be performed by the UE sensing component 199.

In some aspects, the one or more sensing resources may include multiple sensing resources, and the multiple sensing resources may overlap with the DL resource. In some examples, the term “overlap with the DL resource” may indicate at least a partial intersection with the DL resource. For example, a portion of the multiple sensing resources may overlap with the DL resource, while some other portions of the multiple may not overlap with the DL resource. For example, referring to FIG. 5, the one or more sensing resources (allocated at 510) may include multiple sensing resources, and the multiple sensing resources may overlap with the DL resource.

In some aspects, to transmit the sensing configuration (at 906), the network entity may transmit, for the UE, the sensing configuration via common RRC signaling. For example, referring to FIG. 5, the network entity (base station 504) may transmit, at 510, the sensing configuration for the UE 502 via common RRC signaling.

In some aspects, to transmit the sensing configuration (at 906), the network entity may transmit, for the UE, the sensing configuration via dedicated RRC signaling. For example, referring to FIG. 5, the network entity (base station 504) may transmit, at 510, the sensing configuration for the UE 502 via dedicated RRC signaling.

In some aspects, at 908, the network entity may transmit, for the UE, a transmission indication that indicates the one sensing resource from the one or more sensing resources to initiate the UE to transmit the sensing signal using the one sensing resource. The one sensing resource may overlap with the DL resource. For example, referring to FIG. 5, the network entity (base station 504) may transmit, at 512, for the UE 502, a transmission indication that indicates the one sensing resource from the one or more sensing resources to initiate the UE 502 to transmit the sensing signal (at 524) using the one sensing resource. The one sensing resource may overlap with the DL resource. In some aspects, 908 may be performed by the UE sensing component 199.

In some aspects, the one or more sensing resources may include one sensing resource for the UE to transmit the sensing signal. For example, referring to FIG. 5, the one or more sensing resources (allocated at 510) may include one sensing resource for the UE to transmit the sensing signal (at 524).

In some aspects, to transmit the sensing configuration (at 906), the network entity may transmit the sensing configuration via one of: RRC signaling, a MAC-CE, or a PHY layer. For example, referring to FIG. 5, the network entity (base station 504) may transmit the sensing configuration (at 510) via one of: RRC signaling, a MAC-CE, or a PHY layer.

In some aspects, at 904, the network entity may receive, from the UE, a capability indication that indicates the capability of the UE to transmit the sensing signal in the DL resource. To transmit the sensing configuration (at 906), the network entity may transmit the sensing configuration in response to the capability indication. For example, referring to FIG. 5, the network entity (base station 504) may receive, at 508, from the UE, a capability indication that indicates the capability of the UE to transmit the sensing signal in the DL resource. The network entity (base station 504) may transmit the sensing configuration (at 510) in response to the capability indication. In some aspects, 904 may be performed by the UE sensing component 199.

In some aspects, to transmit the sensing configuration (at 906), the network entity may transmit the sensing configuration in response to an operational condition being met. The operational condition may include one or more of: the UE operating in a monostatic sensing mode, uplink resources or flexible resources of the UE being incapable of meeting a sensing condition for the object. The sensing condition may include one or more of: the resource amount condition for sensing the object, or the velocity estimation condition for sensing the object. For example, referring to FIG. 5, the network entity (base station 504) may transmit the sensing configuration (at 510) in response to an operational condition being met. The operational condition may include one or more of: the UE 502 operating in a monostatic sensing mode, uplink resources or flexible resources of the UE 502 being incapable of meeting a sensing condition for the object. The sensing condition may include one or more of: the resource amount condition for sensing the object, or the velocity estimation condition for sensing the object.

In some aspects, at 910, the network entity may transmit, for the UE, a timing indication that indicates a transmission timing configuration associated with the DL resource to initiate the UE to transmit the sensing signal using the transmission timing configuration. For example, referring to FIG. 5, the network entity (base station 504) may transmit, at 516, for the UE 502, a timing indication that indicates a transmission timing configuration associated with the DL resource to initiate the UE 502 to transmit the sensing signal (at 524) using the transmission timing configuration. In some aspects, 910 may be performed by the UE sensing component 199.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The cellular baseband processor(s) 1024 and the application processor(s) 1006 are configured to perform the various functions described supra based at least in part of the information stored in the memory. That is, the cellular baseband processor(s) 1024 and the application processor(s) 1006 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the component 198 may be configured to receive, from a network entity, a sensing configuration allocating one or more sensing resources for a transmission of a sensing signal; and transmit, using one sensing resource of the one or more sensing resources, the sensing signal for sensing an object in the vicinity of the UE. The one sensing resource may overlap with a DL resource. The component 198 may be further configured to perform, based on the sensing signal, a sensing operation on the object. The component 198 may be further configured to perform any of the aspects described in connection with the flowcharts in FIG. 6 and FIG. 7, and/or performed by the UE 502 in FIG. 5. The component 198 may be within the cellular baseband processor(s) 1024, the application processor(s) 1006, or both the cellular baseband processor(s) 1024 and the application processor(s) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, includes means for receiving, from a network entity, a sensing configuration allocating one or more sensing resources for a transmission of a sensing signal, means for transmitting, using one sensing resource of the one or more sensing resources, the sensing signal for sensing an object in the vicinity of the UE, where the one sensing resource overlaps with a DL resource, and means for performing, based on the sensing signal, a sensing operation on the object. The apparatus 1004 may further include means for performing any of the aspects described in connection with the flowcharts in FIG. 6 and FIG. 7, and/or aspects performed by the UE 502 in FIG. 5. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

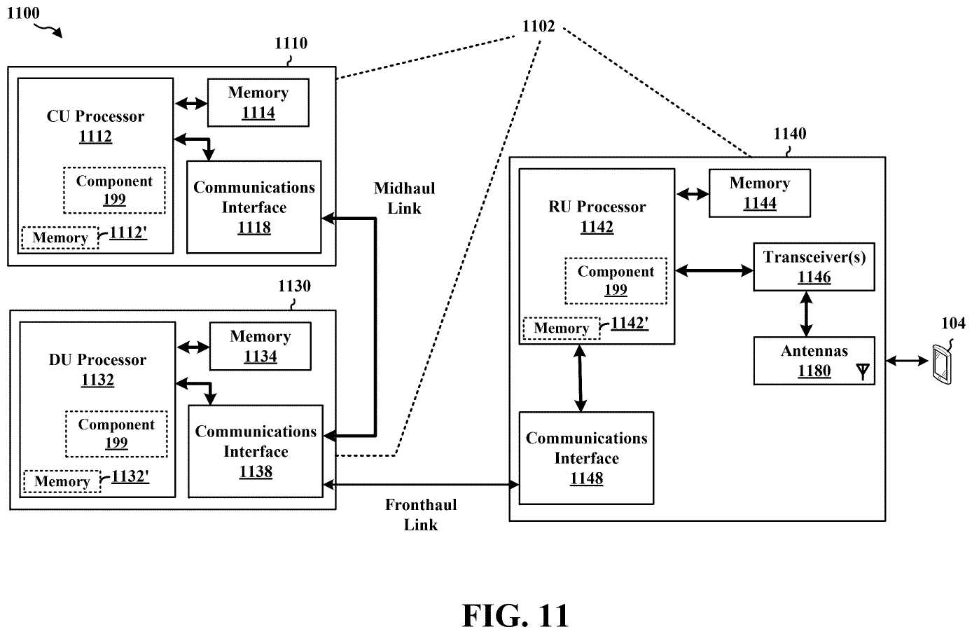

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a UE, a TDD configuration, where the TDD configuration allocates a DL resource; and transmit, for the UE, a sensing configuration allocating one or more sensing resources to initiate the UE to transmit a sensing signal for sensing an object in the vicinity of the UE using the one or more sensing resources. The one or more sensing resources overlap with the DL resource. The component 199 may be further configured to perform any of the aspects described in connection with the flowcharts in FIG. 8 and FIG. 9, and/or performed by the base station 504 in FIG. 5. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 includes means for transmitting, for a UE, a TDD configuration, where the TDD configuration allocates a DL resource, and means for transmitting, for the UE, a sensing configuration allocating one or more sensing resources to initiate the UE to transmit a sensing signal for sensing an object in the vicinity of the UE using the one or more sensing resources. The one or more sensing resources may overlap with the DL resource. The network entity 1102 may further include means for performing any of the aspects described in connection with the flowcharts in FIG. 8 and FIG. 9, and/or aspects performed by the base station 504 in FIG. 5. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a sensing configuration allocating one or more sensing resources for a transmission of a sensing signal; transmitting, using one sensing resource of the one or more sensing resources, the sensing signal for sensing an object in the vicinity of the UE, where the one sensing resource overlaps with a DL resource; and performing, based on the sensing signal, a sensing operation on the object. The methods enable the UE to transmit the sensing signal in DL slots/symbols, which addresses the challenge of balancing the DL-heavy TDD configuration in, for example, mmWave spectrum with the limited resources for sensing signal transmission. These methods provide an efficient way to utilize the existing communication resources for enhanced sensing capabilities, thereby improving the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE). The method may include receiving, from a network entity, a sensing configuration allocating one or more sensing resources for a transmission of a sensing signal; transmitting, using one sensing resource of the one or more sensing resources, the sensing signal for sensing an object in the vicinity of the UE, where the one sensing resource overlaps with a downlink (DL) resource; and performing, based on the sensing signal, a sensing operation on the object.

Aspect 2 is the method of aspect 1, wherein the sensing signal may be in a millimeter wave (mmW) frequency band, and the sensing signal may use one of a cyclic prefix orthogonal frequency division multiplexing (CP-OFDM) waveform or a frequency modulated continuous wave (FMCW) waveform.

Aspect 3 is the method of any of aspects 1 to 2, where the method may further include: receiving, prior to the reception of the sensing configuration, a time division duplexing (TDD) configuration. The TDD configuration may allocate the DL resource.

Aspect 4 is the method of aspect 3, where the TDD configuration may be a common TDD configuration.

Aspect 5 is the method of any of aspects 3 to 4, where the one or more sensing resources may include multiple sensing resources, and the multiple sensing resources may overlap with the DL resource.

Aspect 6 is the method of any of aspects 1 to 5, where receiving the sensing configuration may include: receiving, from the network entity, the sensing configuration via common radio resource control (RRC) signaling.

Aspect 7 is the method of any of aspects 1 to 5, where receiving the sensing configuration may include: receiving, from the network entity, the sensing configuration via dedicated radio resource control (RRC) signaling.

Aspect 8 is the method of aspect 3, where the method may further include: receiving, from the network entity prior to the transmission of the sensing signal, a transmission indication that indicates the one sensing resource from the one or more sensing resources for the transmission of the sensing signal.

Aspect 9 is the method of any of aspects 3 and 8, where the method may further include: selecting the one sensing resource from the one or more sensing resources for the transmission of the sensing signal.

Aspect 10 is the method of any of aspects 3 and 8 to 9, where the one or more sensing resources may include the one sensing resource for the transmission of the sensing signal. Receiving the sensing configuration may include: receiving the sensing configuration via one of: radio resource control (RRC) signaling, a medium access control (MAC)-control element (MAC-CE), or a physical (PHY) layer.

Aspect 11 is the method of any of aspects 3 and 8 to 10, where the method may further include: transmitting, to the network entity prior to the reception of the sensing configuration, a capability indication that indicates the capability of the UE to transmit the sensing signal in the DL resource. The sensing configuration may be based on the capability indication.

Aspect 12 is the method of any of aspects 3 and 8 to 11, where receiving the sensing configuration may include: receiving the sensing configuration in response to the UE operating in a monostatic sensing mode.

Aspect 13 is the method of any of aspects 3 and 8 to 12, where receiving the sensing configuration may include: receiving the sensing configuration in response to uplink resources or flexible resources incapable of meeting a sensing condition. The sensing condition may include one or more of: a resource amount condition for sensing the object, or a velocity estimation condition for sensing the object.

Aspect 14 is the method of any of aspects 3 and 8 to 13, where the sensing signal may be a tracking signal including a tracking duration, and the method may further include: transmitting, using a scanning resource prior to the transmission of the tracking signal, a scanning signal. The scanning signal may include a scanning duration less than the tracking duration, and the scanning resource may not overlap with a DL resource.

Aspect 15 is the method of any of aspects 3 and 8 to 14, where transmitting the sensing signal may include: transmitting the sensing signal using a transmission timing configuration. The transmission timing configuration may be based on a DL timing associated with the DL resource.

Aspect 16 is the method of aspect 15, where the method may further include: receiving, from the network entity prior to the transmission of the sensing signal, a timing indication that indicates the DL timing associated with the DL resource.

Aspect 17 is the method of aspect 15, where the method may further include: determining the transmission timing configuration based on the DL timing associated with the DL resource.

Aspect 18 is the method of aspect 3, where the method may further include: receiving, from the network entity prior to the transmission of the sensing signal, a timing indication that indicates a transmission timing configuration for the sensing signal. Transmitting the sensing signal may include: transmitting the sensing signal using the transmission timing configuration.

Aspect 19 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1-18.

Aspect 20 is the apparatus for wireless communication at a UE, comprising means for performing each step in the method of any of aspects 1-18.

Aspect 21 is an apparatus of any of aspects 19-20, further comprising a transceiver configured to receive or to transmit in association with the method of any of aspects 1-18.

Aspect 22 is a computer-readable medium (e.g., a non-transitory computer-readable medium) storing computer executable code at a UE, the code when executed by at least one processor causes the at least one processor to, individually or in any combination, perform the method of any of aspects 1-18.

Aspect 23 is a method of wireless communication at a network entity. The method may include transmitting, for a user equipment (UE), a time division duplexing (TDD) configuration, where the TDD configuration allocates a downlink (DL) resource; transmitting, for the UE, a sensing configuration allocating one or more sensing resources to initiate the UE to transmit a sensing signal for sensing an object in the vicinity of the UE using the one or more sensing resources, where the one or more sensing resources overlap with the DL resource.

Aspect 24 is the method of aspect 23, where the one or more sensing resources may include multiple sensing resources, and the multiple sensing resources may overlap with the DL resource.

Aspect 25 is the method of any of aspects 23 to 24, where transmitting the sensing configuration may include: transmitting, for the UE, the sensing configuration via common radio resource control (RRC) signaling.

Aspect 26 is the method of any of aspects 23 to 24, where transmitting the sensing configuration may include: transmitting, for the UE, the sensing configuration via dedicated radio resource control (RRC) signaling.

Aspect 27 is the method of any of aspects 23 to 26, where the method may further include: transmitting, for the UE, a transmission indication that indicates the one sensing resource from the one or more sensing resources to initiate the UE to transmit the sensing signal using the one sensing resource. The one sensing resource may overlap with the DL resource.

Aspect 28 is the method of any of aspects 23 to 27, where the one or more sensing resources may include one sensing resource for the UE to transmit the sensing signal.

Aspect 29 is the method of aspect 28, where transmitting the sensing configuration may include: transmitting the sensing configuration via one of: radio resource control (RRC) signaling, a medium access control (MAC)-control element (MAC-CE), or a physical (PHY) layer.

Aspect 30 is the method of any of aspects 23 to 24, where the method may further include: receiving, from the UE, a capability indication that indicates the capability of the UE to transmit the sensing signal in the DL resource. Transmitting the sensing configuration may include: transmitting the sensing configuration in response to the capability indication.

Aspect 31 is the method of any of aspects 23 to 24, where transmitting the sensing configuration may include: transmitting the sensing configuration in response to an operational condition being met, and the operational condition may include one or more of: the UE operating in a monostatic sensing mode, uplink resources or flexible resources of the UE being incapable of meeting a sensing condition for the object. The sensing condition may include one or more of: a resource amount condition for sensing the object, or a velocity estimation condition for sensing the object.

Aspect 32 is the method of any of aspects 23 to 24, where the method may further include: transmitting, for the UE, a timing indication that indicates a transmission timing configuration associated with the DL resource to initiate the UE to transmit the sensing signal using the transmission timing configuration.

Aspect 33 is an apparatus for wireless communication at a network entity, comprising: at least one memory; and at least one processor coupled to the at least one memory and, based at least in part on information stored in the at least one memory, the at least one processor, individually or in any combination, is configured to perform the method of any of aspects 23-32.

Aspect 34 is the apparatus for wireless communication at a network entity, comprising means for performing each step in the method of any of aspects 23-32.

Aspect 35 is an apparatus of any of aspects 33-34, further comprising a transceiver configured to receive or to transmit in association with the method of any of aspects 23-32.

Aspect 36 is a computer-readable medium (e.g., a non-transitory computer-readable medium) storing computer executable code at a network entity, the code when executed by at least one processor causes the at least one processor to, individually or in any combination, perform the method of any of aspects 23-32.

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network entity, a sensing configuration allocating one or more sensing resources for a transmission of a sensing signal;
transmit, using one sensing resource of the one or more sensing resources, the sensing signal for sensing an object in a vicinity of the UE, wherein the one sensing resource overlaps with a downlink (DL) resource; and
perform, based on the sensing signal, a sensing operation on the object.

2. The apparatus of claim 1, further comprising a transceiver coupled to the at least one processor, wherein, to receive the sensing configuration, the at least one processor, individually or in any combination, is configured to receive the sensing configuration via the transceiver, and wherein the sensing signal is in a millimeter wave (mmW) frequency band, and the sensing signal uses one of a cyclic prefix orthogonal frequency division multiplexing (CP-OFDM) waveform or a frequency modulated continuous wave (FMCW) waveform.

3. The apparatus of claim 1, wherein the at least one processor, individually or in any combination, is further configured to:
receive, prior to a reception of the sensing configuration, a time division duplexing (TDD) configuration, wherein the TDD configuration allocates the DL resource.

4. The apparatus of claim 3, wherein the TDD configuration is a common TDD configuration.

5. The apparatus of claim 3, wherein the one or more sensing resources include multiple sensing resources, and wherein the multiple sensing resources overlap with the DL resource.

6. (canceled)

7. (canceled)

8. The apparatus of claim 3, wherein the at least one processor, individually or in any combination, is further configured to:
receive, from the network entity prior to the transmission of the sensing signal, a transmission indication that indicates the one sensing resource from the one or more sensing resources for the transmission of the sensing signal.

9. The apparatus of claim 3, wherein the at least one processor, individually or in any combination, is further configured to:
select the one sensing resource from the one or more sensing resources for the transmission of the sensing signal.

10. The apparatus of claim 3, wherein the one or more sensing resources includes the one sensing resource for the transmission of the sensing signal, and wherein, to receive the sensing configuration, the at least one processor, individually or in any combination, is configured to:
receive the sensing configuration via one of:
radio resource control (RRC) signaling,
a medium access control (MAC)-control element (MAC-CE), or
a physical (PHY) layer.

11. The apparatus of claim 3, wherein the at least one processor, individually or in any combination, is further configured to:
transmit, to the network entity prior to the reception of the sensing configuration, a capability indication that indicates a capability of the UE to transmit the sensing signal in the DL resource, and wherein the sensing configuration is based on the capability indication.

12. The apparatus of claim 3, wherein, to receive the sensing configuration, the at least one processor, individually or in any combination, is configured to:
receive the sensing configuration in response to the UE operating in a monostatic sensing mode.

13. The apparatus of claim 3, wherein, to receive the sensing configuration, the at least one processor, individually or in any combination, is configured to:
receive the sensing configuration in response to uplink resources or flexible resources incapable of meeting a sensing condition, wherein the sensing condition includes one or more of:
a resource amount condition for sensing the object, or
a velocity estimation condition for sensing the object.

14. The apparatus of claim 3, wherein the sensing signal is a tracking signal including a tracking duration, and wherein the at least one processor, individually or in any combination, is further configured to:
transmit, using a scanning resource prior to the transmission of the tracking signal, a scanning signal, wherein the scanning signal includes a scanning duration less than the tracking duration, wherein the scanning resource does not overlap with a DL resource.

15. The apparatus of claim 3, wherein, to transmit the sensing signal, the at least one processor, individually or in any combination, is configured to:
transmit the sensing signal using a transmission timing configuration, wherein the transmission timing configuration is based on a DL timing associated with the DL resource.

16. The apparatus of claim 15, wherein the at least one processor, individually or in any combination, is further configured to:
receive, from the network entity prior to the transmission of the sensing signal, a timing indication that indicates the DL timing associated with the DL resource.

17. The apparatus of claim 15, wherein the at least one processor, individually or in any combination, is further configured to:
determine the transmission timing configuration based on the DL timing associated with the DL resource.

18. The apparatus of claim 3, wherein the at least one processor, individually or in any combination, is further configured to:
receive, from the network entity prior to the transmission of the sensing signal, a timing indication that indicates a transmission timing configuration for the sensing signal, and wherein, to transmit the sensing signal, the at least one processor, individually or in any combination, is configured to:
transmit the sensing signal using the transmission timing configuration.

19. An apparatus for wireless communication at a network entity, comprising:
at least one memory; and
at least one processor coupled to the at least one memory and, based at least in part on information stored in the at least one memory, the at least one processor, individually or in any combination, is configured to:
transmit, for a user equipment (UE), a time division duplexing (TDD) configuration, wherein the TDD configuration allocates a downlink (DL) resource; and
transmit, for the UE, a sensing configuration allocating one or more sensing resources to initiate the UE to transmit a sensing signal for sensing an object in a vicinity of the UE using the one or more sensing resources, wherein the one or more sensing resources overlap with the DL resource.

20. The apparatus of claim 19, further comprising a transceiver coupled to the at least one processor, wherein, to transmit the sensing configuration, the at least one processor, individually or in any combination, is configured to transmit the sensing configuration via the transceiver, and wherein the one or more sensing resources include multiple sensing resources, and wherein the multiple sensing resources overlap with the DL resource.

21. (canceled)

22. (canceled)

23. (canceled)

24. (canceled)

25. (canceled)

26. The apparatus of claim 19, wherein the at least one processor, individually or in any combination, is further configured to:
receive, from the UE, a capability indication that indicates a capability of the UE to transmit the sensing signal in the DL resource, and wherein, to transmit the sensing configuration, the at least one processor, individually or in any combination, is further configured to:
transmit the sensing configuration in response to the capability indication.

27. (canceled)

28. (canceled)

29. A method of wireless communication at a user equipment (UE), comprising:
receiving, from a network entity, a sensing configuration allocating one or more sensing resources for a transmission of a sensing signal;
transmitting, using one sensing resource of the one or more sensing resources, the sensing signal for sensing an object in a vicinity of the UE, wherein the one sensing resource overlaps with a downlink (DL) resource; and
performing, based on the sensing signal, a sensing operation on the object.

30. (canceled)
